(19) United States
(12) Patent Application Publication
(10) Pub. No.: US 2015/0020209 A1
(43) Pub. Date: Jan. 15, 2015

(54) AUTO-SHARING OF SENSITIVE DATA

(71) Applicant: INTERNATIONAL BUSINESS MACHINES CORPORATION, Armonk, NY (US)

(72) Inventors: ALBERT D. BENNAH, CARY, NC (US); GERALD A. PRICE, DURHAM, NC (US); JOHN C. RICHARD, KNIGHTDALE, NC (US)

(21) Appl. No.: 13/937,800

(22) Filed: Jul. 9, 2013

(51) Int. Cl. G06F 21/62

(52) U.S. Cl. CPC G06F 21/62
USPC 726/27

(57) ABSTRACT

A method, computer system, and/or computer program product shares sensitive data. Sensitive data about a user of a first device is stored within the first device. The sensitive data within the first device is classified into different sensitive data tiers. A determination is made, by one or more processors, as to which tier level of sensitive data from the different sensitive data tiers is appropriate for sharing with a second device, where determining an appropriateness of sharing a particular tier level of sensitive data is based on a current contextual circumstance of the user of the first device. The appropriate tier level sensitive data is transmitted from the first device to the second device.

### BACKGROUND

The present disclosure relates to the field of computers, and specifically to computers that store sensitive data. Still more particularly, the present disclosure relates to sharing sensitive data between computers.

In business transactions such as applying for mortgages, a significant amount of sensitive data is provided by applicants. This is usually done through tediously repetitive and often error-prone methods, such as filling out a physical form. Furthermore, many such transactions require that identical sensitive information be provided on many separate forms.

### SUMMARY

A method, computer system, and/or computer program product shares sensitive data. Sensitive data about a user of a first device is stored within the first device. The sensitive data within the first device is classified into different sensitive data tiers. A determination is made, by one or more processors, as to which tier level of sensitive data from the different sensitive data tiers is appropriate for sharing with a second device, where determining an appropriateness of sharing a particular tier level of sensitive data is based on a current contextual circumstance of the user of the first device. The appropriate tier level of sensitive data is transmitted from the first device to the second device.

### BRIEF DESCRIPTION OF THE SEVERAL VIEWS OF THE DRAWINGS

FIG. 1 depicts an exemplary computer in which the present disclosure may be implemented;

FIG. 2 is a high level flow chart of one or more exemplary steps taken by one or more processors to share sensitive data between two devices; and

FIG. 3 illustrates an exemplary data tier graph of multiple sensitive data tiers.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

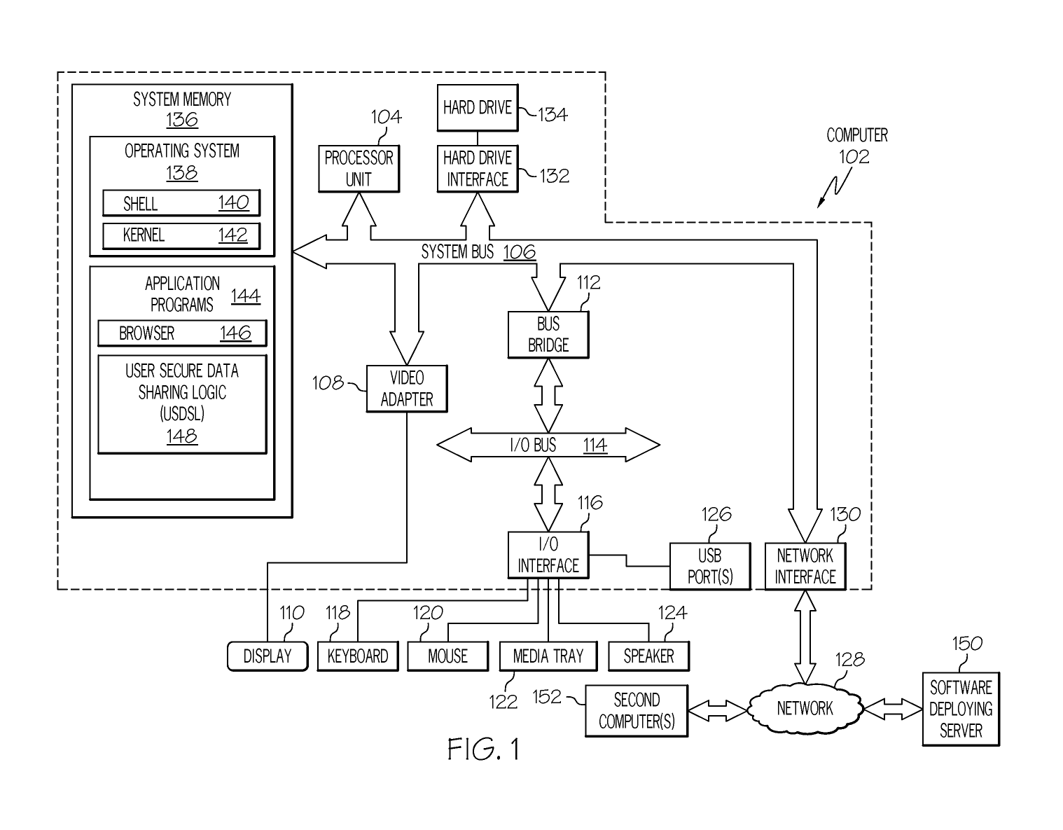

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150, and/or second computer(s) 152.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or transaction executing computer system(s) 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

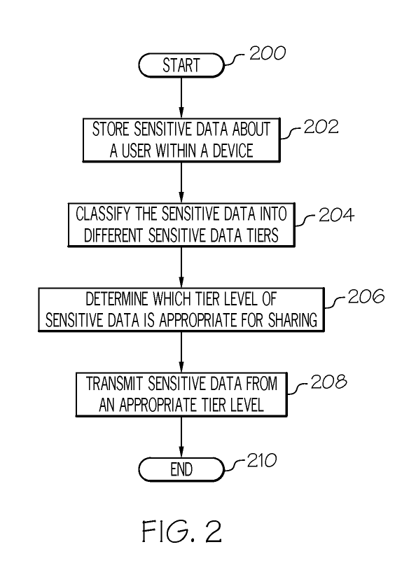

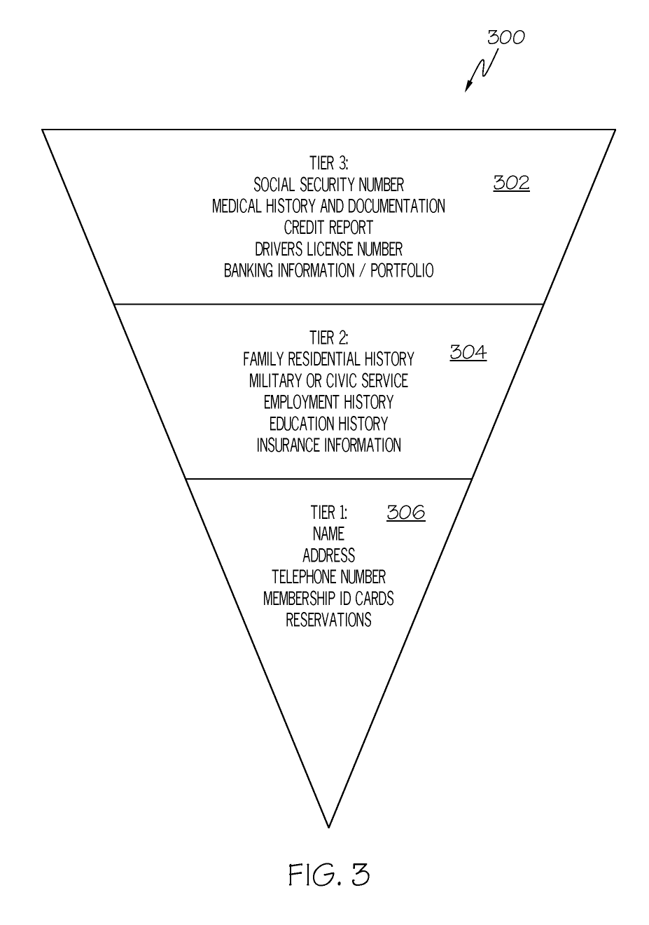

Application programs 144 in computer 102's system memory (as well as software deploying server 150's system memory) also include a user secure data sharing logic (USDSL) 148. USDSL 148 includes code for implementing the processes described below, including those described in FIGS. 2-3. In one embodiment, computer 102 is able to download USDSL 148 from software deploying server 150, including in an on-demand basis, such that the code from USDSL 148 is not downloaded until runtime or otherwise immediately needed by computer 102. Note further that, in one embodiment of the present disclosure, software deploying server 150 performs all of the functions associated with the present disclosure (including execution of USDSL 148), thus freeing computer 102 from having to use its own internal computing resources to execute USDSL 148.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

With reference now to FIG. 2, a high level flow chart of one or more steps taken by one or more processors to share sensitive data between two devices is presented. After initiator 200, sensitive data about a user of a first device is stored within the first device (block 202). In one embodiment, the storing of this sensitive data is initiated in response to a user uploading sensitive data into the first device, which in one embodiment is a mobile device. Exemplary mobile devices include, but are not limited to, a cell phone, a tablet, or any other mobile computing device.

Referring now to FIG. 3, exemplary types and tiers of sensitive data are presented in data tier graph 300, which depicts multiple sensitive data tiers 302 (“Tier 3”), 304 (“Tier 2”), and 306 (“Tier 1”). As depicted, exemplary data from Tier 1 (306) includes data such as a user's telephone number, name, address, club membership identification, reservations for dinner, travel, etc. Exemplary data from Tier 2 (304), which is more sensitive than data found in Tier 1, includes the same user's residential history, military service record, employment history, and/or education level. Exemplary data from Tier 3 (302), which is more sensitive than data found in Tier 2, includes the same user's social security number, medical history, credit information, driver's license number, banking information, etc.

Note that in one embodiment, the sensitive information depicted in data tier graph 300, and thus stored with the first device, is all for a same singular person. In another embodiment, however, different tiers are reserved for different persons. For example, assume that the user of the first device is a parent who is taking her son to a doctor's appointment. As such, sensitive data stored in the portable device may include Tier 3 medical information about the son (but not the parent), as well as Tier 2 insurance information about the parent (who owns the policy, is responsible for the medical bill, etc.).

Note further that, in one embodiment, tier-level data, and the transmission thereof as described herein, may be tier selective. For example, assume that a decision is made to send Tier 2 level data from a first device to a second device. In one example, this decision allows both Tier 2 and Tier 1 level data to be sent from the first device to the second device. In another embodiment, however, only Tier 2 level data will be sent from the first device to the second device, without sending any of the Tier 1 level data.

Referring again to FIG. 2, and specifically to block 204, the sensitive data is then classified, by one or more processors, into different sensitive data tiers, such as those depicted in FIG. 3. That is, the sensitive data is sorted and classified according to sensitive data tier parameters that, in one embodiment, have been determined by the user. That is, in one embodiment, the user will manually assign various types of data into a specific tier. However, in another embodiment, the tier parameters are automatically determined (e.g., by USDSL 148 depicted in FIG. 1) according to predetermined factors, such as legal requirements (e.g., statutes related to corporate accounting transparency with the public), enterprise-wide guidelines, “best business practices”, etc.

As described in block 206, a determination is made, by one or more processors, as to which tier level of sensitive data from the different sensitive data tiers is appropriate for sharing with a second device. This determination of appropriateness of sharing a particular tier level of sensitive data is based on a current contextual circumstance of the user of the first device. The current contextual circumstance may be temporal, geographic, purpose-driven, etc.

For example, in one embodiment the current contextual circumstance of the user is derived from an input from the user, which is received by the first portable device used by the user. This user input defines the current contextual circumstance according to a current physical environment of the user and a purpose of the user being in the current physical environment. For example, the user may input that he is at his son's doctor's office (a “current physical environment”) for an annual checkup (a “purpose of the user being in the current physical environment”).

Similarly, in a first scenario the user may input that she is at a car dealership (“current physical environment”) for the purpose of comparing prices of cars, but not buying a car at the present time (“purpose of the user being in the current physical environment”). In a second scenario, the user may input that she is at a car dealership (“current physical environment”), but now the purpose is to buy a car (“purpose of the user being in the current physical environment”). Thus, in the first scenario data from a lower tier level is used, while in the second scenario data from a higher level is utilized. For example, banking and credit information may be inappropriate for sharing with a car dealership if only comparing vehicles, but would be appropriate to share if in the process of buying a vehicle. Thus, only data from Tier 1 in the data tier graph 300 from FIG. 3 is shared in the first scenario, while data from Tier 3 in data tier graph 300 is shared in the second scenario.

In one embodiment, the location of a user of the first device, as well as the purpose for that user being at that location, is derived from a user inputting this information into the first device, in order to control what tier-level of data will be shared at that location. However, in one embodiment, this information is pre-loaded by the user into the first device, such that the input from the user predefines the current contextual circumstance according to a future physical environment of the user and a purpose of the user traveling to the future physical environment.

In one embodiment, determining the current contextual circumstance according to a current physical environment of the user and a purpose of the user being in the current physical environment is accomplished by hardware and/or software logic. For example, the first device may be enabled with a global positioning system (GPS) monitoring device. The first device, knowing its current location, then cross-references this current location with a look-up table of known businesses, residences, etc. and their operations/functions/etc. For example, if the first device determines, based on a current reading from its GPS monitoring device and information from a lookup table, that the user is currently located in a doctor's office, the first device will then know what tier-level of data should be shared with that doctor's office. In one embodiment, the first device will further communicate with its internal memory and/or other devices (e.g., second computer(s) 152 shown in FIG. 1) to further determine the purpose of the visit to that doctor's office. For example, assume that the first device includes a calendar for the user of the first device, and the calendar recognizes that the user is on a follow-up visit to the doctor's office. The information provided by the first device to the system at the doctor's office will be different from that provided on a first visit as a new patient.

In another example, assume that the first device is a portable device, and a second device with which information is being shared is an airline kiosk at an airport. Assume further in this embodiment that the first device and the airline kiosk are able to automatically establish a communication link, such as via a near field communication (NFC) link. An NFC link is caused by the first device broadcasting a short-distance (e.g., less than 10′) interrogation message. The airline kiosk recognizes this NFC interrogation message, and responds with a message initiating a communication session with the first device. The first device then sends appropriate information to the airline kiosk base on 1) an identity of the airline kiosk; 2) a GPS/lookup table based determination of the purpose of the user of the first device being at the airport; and/or 3) user/calendar inputs on the first device.

In another example, assume that the user is a bank customer is at a bank location, perhaps at a kiosk such as an Automated Teller Machine (ATM). A user of the first device (e.g., a smart phone) inputs in this example a purpose of the visit to the bank/ATM. If the purpose is just to check on a balance of an existing account, the tier-level of information (e.g., account number without a personal identification number) transmitted will be different than the tier-level of information needed for a loan or credit card application (e.g., employment history, social security number, financial return information, etc.).

In another example, assume that two individuals have a business relationship. If the purpose/context of their meeting is truly a business-to-business (B2B) context, such as negotiating a contract, then the tier-level data being automatically transmitted will be different than if the visit is purely social (e.g., setting up a date for a social outing). The context of the meeting, and thus the tier-level to be shared, is determined by any of the processes described herein, including but not limited to, a user's manual input/selection of a topic/context for the meeting, a determination made based on readings from GPS, a lookup table, a user's calendar, etc.

With reference again to FIG. 2, and particularly as described in block 208, sensitive data from an appropriate tier level is then transmitted from the first device to the second device, where the appropriate tier level is based on the current contextual circumstance of the user of the first device as described herein.

In one embodiment, the sensitive data that is transmitted (block 208) is coupled with an auto-populate applet. This auto-populate applet is defined as any digital instruction, readable by a second device that receives the sensitive data, to auto-populate the transmitted sensitive data from the appropriate tier level into a particular form/table/etc. For example, assume that the transmitted sensitive data includes Tier 1 level data, Tier 2 level data, and Tier 3 level data. The auto-populate applet causes the recipient second device to populate a first application and/or first form and/or portion of a form with all or a portion of the Tier 1 level data; a second application and/or a second form and/or portion of a form with all or a portion of the Tier 2 level data; and/or a third application and/or a third form and/or portion of a form with all or a portion of the Tier 3 level data.

The transmitted sensitive data from an appropriate tier level is used by the second device to automatically populate necessary forms that are within the second device. The data packet sent from the first device to the second device may include more than one sensitive data tier. That is in one embodiment, when a higher level is deemed necessary all subordinate levels are included when the sensitive data is transmitted. In this way, the second device is able to use information from both a more secure tier level, and a less secure tier level to auto-populate forms that require secure, accurate, precise populating such as medical, business-related, or non-commercial forms. The process ends at termination block 210.

As described herein, the present invention enables a first user to keep his/her unique information on a mobile device that sends such information to the user's device of choice. This information is categorized and subcategorized in order to provide the correct level of security for the information. In accordance with one embodiment of the present invention, a higher the level of security placed on a particular information item restricts access to that piece of information. That is, not all information about a particular user requires a high level of security. For example, a gate code would not require the same level security as a user's banking information. The present application addresses these issues through the use of selectively adjustable tiers for classifying sensitive data.

In one embodiment, the system comprises a portable device, such as a tablet computer with the ability to host a multi-tier data repository containing data about one or more persons. This portable device provides remote access via means such as a Wi-Fi hot spot, near field communication (NFC), etc. Upon establishing a communication session between the portable device and a trusted client device, the portable device has the ability to grant an appropriate level of access (to sensitive data) to the trusted client device. In one embodiment, the trusted client device is an intelligent client device, such as a loan application kiosk, which is capable of establishing a connection to the portable device. In one embodiment, the trusted client device has the ability to decode and process data retrieved from a portable device.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A method of sharing sensitive data, the method comprising:
storing, within a first device, sensitive data about a user of the first device;
classifying, by one or more processors, the sensitive data into different sensitive data tiers;
determining, by one or more processors, which tier level of sensitive data from the different sensitive data tiers is appropriate for sharing with a second device, wherein determining an appropriateness of sharing a particular tier level of sensitive data is based on a current contextual circumstance of the user of the first device; and
transmitting sensitive data from an appropriate tier level to the second device, wherein the appropriate tier level is based on the current contextual circumstance of the user of the first device.

2. The method of claim 1, further comprising:
receiving, by one or more processors, an input from the user, wherein the input defines the current contextual circumstance according to a current physical environment of the user and a purpose of the user being in the current physical environment.

3. The method of claim 1, further comprising:
receiving, by one or more processors, an input from the user, wherein the input predefines the current contextual circumstance according to a future physical environment of the user and a purpose of the user traveling to the future physical environment.

4. The method of claim 1, further comprising:
determining, by one or more processors, the current contextual circumstance according to a current physical environment of the user and a purpose of the user being in the current physical environment.

5. The method of claim 4, wherein the current physical environment is determined by a global positioning system (GPS) on the first device, and wherein the purpose of the user being in the current physical environment is determined from an entry into a scheduling application used by the user of the first device.

6. The method of claim 1, further comprising:
inserting, by one or more processors, an auto-populate applet into the sensitive data from the appropriate tier level, wherein the auto-populate applet causes the second device to auto-populate a form with at least a portion of the sensitive data as instructed by the auto-populate applet.

7. The method of claim 1, further comprising:
transmitting sensitive data from a lower tier level to the second device, wherein the lower tier level contains data that is classified as being less sensitive than data in the appropriate tier level.

8. A computer program product for sharing sensitive data, the computer program product comprising a tangible computer readable storage medium having program code embodied therewith, the program code readable and executable by a processor to perform a method comprising:
storing, within a first device, sensitive data about a user of the first device;
classifying, by one or more processors, the sensitive data into different sensitive data tiers;
determining, by one or more processors, which tier level of sensitive data from the different sensitive data tiers is appropriate for sharing with a second device, wherein determining an appropriateness of sharing a particular tier level of sensitive data is based on a current contextual circumstance of the user of the first device; and
transmitting sensitive data from an appropriate tier level to the second device, wherein the appropriate tier level is based on the current contextual circumstance of the user of the first device.

9. The computer program product of claim 8, wherein the method further comprises:
receiving, by one or more processors, an input from the user, wherein the input defines the current contextual circumstance according to a current physical environment of the user and a purpose of the user being in the current physical environment.

10. The computer program product of claim 8, wherein the method further comprises:
receiving, by one or more processors, an input from the user, wherein the input predefines the current contextual circumstance according to a future physical environment of the user and a purpose of the user traveling to the future physical environment.

11. The computer program product of claim 8, wherein the method further comprises:
determining, by one or more processors, the current contextual circumstance according to a current physical environment of the user and a purpose of the user being in the current physical environment.

12. The computer program product of claim 11, wherein the current physical environment is determined by a global positioning system (GPS) on the first device, and wherein the purpose of the user being in the current physical environment is determined from an entry into a scheduling application used by the user of the first device.

13. The computer program product of claim 8, wherein the method further comprises:
inserting, by one or more processors, an auto-populate applet into the sensitive data from the appropriate tier level, wherein the auto-populate applet causes the second device to auto-populate a form with at least a portion of the sensitive data as instructed by the auto-populate applet.

14. The computer program product of claim 8, wherein the method further comprises:
transmitting sensitive data from a lower tier level to the second device, wherein the lower tier level contains data that is classified as being less sensitive than data in the appropriate tier level.

15. A computer system comprising:
a processor, a computer readable memory, and a computer readable storage medium;
first program instructions to store, within a first device, sensitive data about a user of the first device;
second program instructions to classify the sensitive data into different sensitive data tiers;
third program instructions to determine which tier level of sensitive data from the different sensitive data tiers is appropriate for sharing with a second device, wherein determining an appropriateness of sharing a particular tier level of sensitive data is based on a current contextual circumstance of the user of the first device;
fourth program instruction to transmit sensitive data from an appropriate tier level to the second device, wherein the appropriate tier level is based on the current contextual circumstance of the user of the first device; and wherein
said first, second, third, and fourth program instructions are stored on said computer readable storage medium for execution by said processor via said computer readable memory.

16. The computer system of claim 15, further comprising:
fifth program instructions to receive an input from the user, wherein the input defines the current contextual circumstance according to a current physical environment of the user and a purpose of the user being in the current physical environment; and wherein
the fifth program instructions are stored on said computer readable storage medium for execution by said processor via said computer readable memory.

17. The computer system of claim 15, further comprising:
fifth program instructions to receive an input from the user, wherein the input predefines the current contextual circumstance according to a future physical environment of the user and a purpose of the user traveling to the future physical environment; and wherein
the fifth program instructions are stored on said computer readable storage medium for execution by said processor via said computer readable memory.

18. The computer system of claim 15, further comprising:
fifth program instructions to determine the current contextual circumstance according to a current physical environment of the user and a purpose of the user being in the current physical environment, wherein the current physical environment is determined by a global positioning system (GPS) on the first device, and wherein the purpose of the user being in the current physical environment is determined from an entry into a scheduling application used by the user of the first device; and wherein
the fifth program instructions are stored on said computer readable storage medium for execution by said processor via said computer readable memory.

19. The computer system of claim 15, further comprising:
fifth program instructions to insert an auto-populate applet into the sensitive data from the appropriate tier level, wherein the auto-populate applet causes the second device to auto-populate a form with at least a portion of the sensitive data as instructed by the auto-populate applet; and wherein
the fifth program instructions are stored on said computer readable storage medium for execution by said processor via said computer readable memory.

20. The computer system of claim 15, further comprising:
fifth program instructions to transmit sensitive data from a lower tier level to the second device, wherein the lower tier level contains data that is classified as being less sensitive than data in the appropriate tier level; and wherein
the fifth program instructions are stored on said computer readable storage medium for execution by said processor via said computer readable memory.
